(19) United States
(12) Patent Application Publication
(10) Pub. No.: US 2026/0233552 A1
(43) Pub. Date: Aug. 13, 2026

(54) Threaded Frameworks

(71) Applicant: Saleel Limaye, Fairview, TX (US)

(72) Inventor: Saleel Limaye, Fairview, TX (US)

(21) Appl. No.: 19/053,271

(22) Filed: Feb. 13, 2025

(51) Int. Cl. B44C 3/12

(52) U.S. Cl. CPC B44C 3/12

(57) ABSTRACT

Examples of threaded frameworks are described. One example of threaded framework includes a base frame, a plurality of anchor structures, and one or more strings. A contour of the base frame forms one or more hollow areas. The plurality of anchor structures are placed along the contour of the base frame. The plurality of anchor structures include one or more U-shaped pins placed on a first surface of the base frame. The one or more strings are threaded through the one or more U-shaped pins to form a pattern within the one or more hollow areas.

### TECHNICAL FIELD

The following disclosure generally relates to structural systems, and in particular, to threaded frameworks and associated threading methods.

### BACKGROUND

String art is a popular craft for home décor, traditionally involving hammering nails into a board and wrapping strings around the nails to create designs. However, maintaining string tension and tying it off can be challenging for users of all ages. Additionally, redesigning often requires rewrapping strings around multiple nails, which can be especially difficult for younger crafters.

### SUMMARY

The present disclosure describes threaded frameworks and methods for threading within a framework.

In a general aspect, a threaded framework comprises a base frame, a plurality of anchor structures, and one or more strings. A contour of the base frame forms one or more hollow areas. The plurality of anchor structures are placed along the contour of the base frame. The plurality of anchor structures comprise one or more U-shaped pins placed on a first surface of the base frame. Each of the one or more U-shaped pins comprises two legs that are in parallel to each another and that are connected by a curved or straight portion. The two legs of a U-shaped pin extend from the first surface of the base frame and are perpendicular to the first surface of the base frame. The one or more strings are threaded through the one or more U-shaped pins to form a pattern within the one or more hollow areas. The one or more strings are configured to pass between the two legs of the one or more U-shaped pins, and the one or more strings are looped around at least one leg of each of the one or more U-shaped pins to maintain tension for the pattern.

Particular embodiments may include one or more of the following features.

In some embodiments, at least one of the one or more strings is threaded sequentially through two adjacent U-shaped pins.

In some embodiments, at least one of the one or more strings is threaded sequentially through two non-adjacent U-shaped pins.

In some embodiments, at least one of the one or more strings is looped around two legs of at least one of the U-shaped pins.

In some embodiments, the threaded framework comprises a first U-shaped pin placed on the first surface of the base frame and a second U-shaped pin placed on a second surface of the base frame, wherein the second surface is opposite to the first surface, and wherein the one or more strings are threaded through at least the first U-shaped pin and the second U-shaped pin.

In some embodiments, the plurality of anchor structures further comprise one or more of the following: a stub, a peg, a nail, a knob, a spike, or a post.

In some embodiments, the plurality of anchor structures comprise one or more of the following materials: metal, plastic, wood, or composite.

In another aspect, a method comprises providing a frame, where a contour of the base frame forms one or more hollow areas. The method further comprises arranging a plurality of anchor structures along the contour of the base frame. The plurality of anchor structures comprise one or more U-shaped pins placed on a first surface of the base frame. Each of the one or more U-shaped pins comprises two legs that are in parallel to each another and that are connected by a curved or straight portion. The two legs of a U-shaped pins extend from the first surface of the base frame and are perpendicular to the first surface of the base frame. The method further comprises threading one or more strings through the one or more U-shaped pins to form a pattern within the one or more hollow areas. The one or more strings are configured to pass between the two legs of the one or more U-shaped pins, and the one or more strings are looped around at least one leg of each of the one or more U-shaped pins to maintain tension for the pattern.

Particular embodiments may include one or more of the following features.

In some embodiments, threading the one or more strings through the one or more U-shaped pins comprises: threading at least one of the one or more strings sequentially through two adjacent U-shaped pins.

In some embodiments, threading the one or more strings through the one or more U-shaped pins comprises: threading at least one of the one or more strings sequentially through two non-adjacent U-shaped pins.

In some embodiments, threading the one or more strings through the one or more U-shaped pins comprises: looping at least one of the one or more strings around two legs of at least one of the U-shaped pins.

In some embodiments, threading the one or more strings through the one or more U-shaped pins comprises: threading the one or more strings through at least a first U-shaped pin placed on the first surface of the base frame and a second U-shaped pin placed on a second surface of the base frame, where the second surface is opposite to the first surface.

In some embodiments, the plurality of anchor structures further comprise one or more of the following: a stub, a peg, a nail, a knob, a spike, or a post.

In some embodiments, the plurality of anchor structures comprise one or more of the following materials: metal, plastic, wood, or composite.

In yet another aspect, a threaded framework comprises a base frame and a plurality of anchor structures. A contour of the base frame forms one or more hollow areas. The plurality of anchor structures are placed along the contour of the base frame. The plurality of anchor structures comprise one or more U-shaped pins placed on a first surface of the base frame. Each of the one or more U-shaped pins comprises two legs that are in parallel to each another and that are connected by a curved or straight portion. The two legs of a U-shaped pins extend from the first surface of the base frame and are perpendicular to the first surface of the base frame. The one or more U-shaped pins are spaced out on the first surface of the base frame and configured to be threaded through by one or more strings to form a pattern within the one or more hollow areas. The one or more strings are configured to pass between the two legs of the one or more U-shaped pins, and the one or more strings are looped around at least one leg of each of the one or more U-shaped pins to maintain tension for the pattern.

Particular embodiments may include one or more of the following features.

In some embodiments, at least one of the one or more strings is threaded sequentially through two adjacent U-shaped pins.

In some embodiments, at least one of the one or more strings is threaded sequentially through two non-adjacent U-shaped pins.

In some embodiments, at least one of the one or more strings is looped around two legs of at least one of the U-shaped pins.

In some embodiments, the threaded framework comprises a first U-shaped pin placed on the first surface of the base frame and a second U-shaped pin placed on a second surface of the base frame. The second surface is opposite to the first surface, and the one or more strings are threaded through at least the first U-shaped pin and the second U-shaped pin.

In some embodiments, the plurality of anchor structures further comprise one or more of the following: a stub, a peg, a nail, a knob, a spike, or a post.

### BRIEF DESCRIPTION OF THE DRAWINGS

FIG. 1 illustrates an example threaded framework, according to one or more embodiments of the present disclosure.

FIG. 2 illustrates another example threaded framework, according to one or more embodiments of the present disclosure.

FIG. 3 illustrates example anchor structures, according to one or more embodiments of the present disclosure.

FIG. 4 illustrates an example threaded framework, according to one or more embodiments of the present disclosure.

FIG. 5 illustrates another example threaded framework, according to one or more embodiments of the present disclosure.

FIG. 6 illustrates another example threaded framework, according to one or more embodiments of the present disclosure.

FIG. 7 illustrates an example method, according to one or more embodiments of the present disclosure.

Like reference numbers and designations in the various drawings indicate like elements.

### DETAILED DESCRIPTION

A threaded framework is a structural or organizational system that incorporates strings threaded through other components on a base frame to achieve both functional and aesthetic objectives. This design leverages the inherent properties of strings to create a framework that is versatile, durable, and adaptable to various applications. By interconnecting or assembling multiple elements, the threaded framework can provide a robust solution for ensuring structural stability and precision.

A threaded framework can distribute stress and tension evenly across the structure, enhancing its overall integrity and performance under diverse conditions. Strings can facilitate precise adjustments and secure fittings, allowing the framework to adapt to a wide range of configurations and specific use cases.

Material compatibility adds another layer of versatility to the threaded framework, as strings can be integrated into structures made from metals, polymers, composites, or other materials. This characteristic can broaden its applicability across industries, ranging from engineering to product design. Moreover, the threaded framework can offer aesthetic benefits. Visible strings threaded on a frame can be designed to provide an intricate, ornamental quality, allowing the framework to serve both utilitarian and decorative purposes. This combination of functionality and visual appeal makes it useful in applications where appearance is integral, such as in consumer products, furniture, or architectural designs.

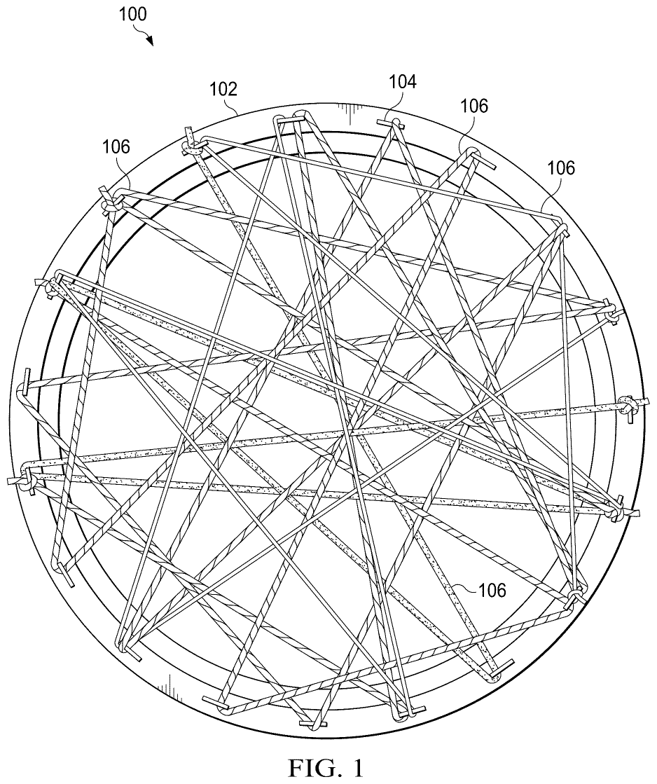

FIG. 1 illustrates an example threaded framework 100, according to one or more embodiments of the present disclosure. The threaded framework 100 comprises a base frame 102, a plurality of anchor structures 104, and one or more strings 106. The base frame 102 serves as the foundational structure and provides overall stability. The anchor structures 104 are positioned to facilitate the threading of strings or other materials. The anchor structures 104 can enable secure attachment points for the threading components, ensuring proper tension and alignment throughout the framework. The strings 106 are threaded through the anchor structures 104 to create a desired configuration or pattern. The strings 106 can serve various purposes, such as providing structural integrity, creating a flexible mesh, or facilitating specific mechanical or aesthetic functionalities.

In some embodiments, the threaded framework 100 comprises additional elements, such as tensioning mechanisms, adjustable components, or decorative features. These additional elements can enhance the functionality, adaptability, or appearance of the framework. For example, tensioning mechanisms could allow for fine-tuning of the string tension, ensuring optimal performance for specific applications. Similarly, decorative components could be integrated to provide an aesthetically pleasing design.

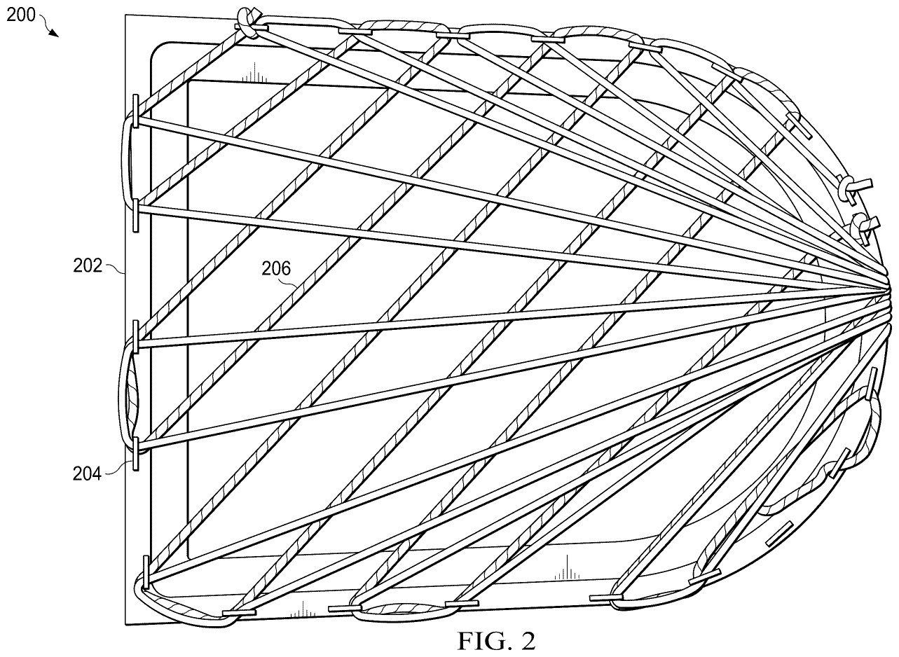

In the example of FIG. 1, the base frame 100 has a circular shape. FIG. 2 presents another example of a threaded framework 200 that comprises a base frame 202 comprising a straight portion and an arched portion. These examples of base frames 102 and 202 are provided for illustrative purposes only and are not intended to limit the scope of this disclosure.

The base frame of a threaded framework can have various shapes and configurations, depending on factors such as its intended purpose, structural requirements, and aesthetic preferences. In some examples, the base frames 102 or 202 can adopt geometric shapes such as a circle, rectangle, square, triangle, hexagon, ellipse, or other polygons. In some examples, the base frames 102 or 202 can have layered or stacked configuration to enhance its functionality. In some examples, the base frames 102 or 202 can also have a freeform or organic shape, allowing for more creative and unconventional designs.

The base frame of a threaded framework can be constructed from a variety of materials, depending on the application requirements, including strength, weight, environmental resistance, and aesthetic considerations. In some examples, the base frames 102 and 202 can be constructed from rigid or semi-rigid materials. In some examples, the base frames 102 and 202 can be metal, such as steel, aluminum, titanium, brass, or copper. In some examples, the base frame 102 and 202 can be polymers, such as polycarbonate, nylon, acrylic, or high-density polyethylene (HDPE). In some examples, the base frames 102 and 202 can be composite, such as carbon fiber reinforced polymers (CFRP), glass giber reinforced polymers (GFRP), or Kevlar composites. In some examples, the base frames 102 and 202 can be a natural material, such as wood or bamboo. In some examples, the base frames 102 and 202 can be advanced material, such as ceramics or graphene.

In some embodiments, a threaded framework comprises a base frame defining one or more hollow areas. A contour of the base frame shapes the hollow areas, influencing the overall structural integrity and visual design of the framework. In the examples of FIGS. 1 and 2, a contour of the base frame 102 or 202 forms a hollow area, which is enclosed by the continuous outline of the base frame. In some examples, the contour can be designed to follow a specific geometric pattern, such as a circle, ellipse, or polygon. In some examples, the contour can adopt an irregular or freeform shape to meet particular design requirements.

The hollow areas formed by the contour of the base frame can be configured to serve as open spaces through which strings or filaments are tensioned, creating a desired ornamental or functional design. This design can introduce both functional and aesthetic features, depending on the application. The hollow area, which can take the form of cutouts, perforations, or enclosed cavities, can contribute to the versatility and adaptability of the threaded framework. Incorporating the hollow areas in the base frames 102 and 202 can reduce the overall weight of the structure without compromising its strength. By introducing hollow sections, the framework can reduce material usage, making the design more cost-effective and sustainable while maintaining necessary structural integrity. Hollow contours can help manage stress distribution within the framework by redirecting forces away from critical points, which can increase the durability of the base frame.

The threaded framework 100 further comprises a plurality of anchor structures 104 spaced apart along the contour on one or more surfaces of the base frame. In some embodiments, the anchor structures 104 serve as anchor points for the strings or filaments, allowing for the creation of patterns within the hollow areas. The spacing and placement of the anchor structures 104 can vary depending on the desired design. In some examples, the anchor structures 104 can be integrally formed with the base frame or attached as separate components.

In some embodiments, the plurality of anchor structures 104 comprise one or more U-shaped pins. The U-shaped pins can be configured as attachment points for the threading components of the framework to securely hold the strings or other materials in place, ensuring proper alignment and stability within the threaded framework.

In some examples, each U-shaped pin comprises two legs that are positioned parallel to each other. The legs are joined at one end by a connecting portion, which can either be curved to form a smooth arc or straight to create a sharp edge. The specific design of the connecting portion can be tailored based on the functional requirements or aesthetic preferences of the framework.

The two legs of a U-shaped pin extend outward from a surface of the base frame, creating an anchor point for threading. The legs can be oriented such that they are perpendicular to the surface of the base frame, forming a stable and upright structure. This perpendicular alignment can ensure that the pins maintain consistent tension on the threaded materials and provide reliable support.

In some embodiments, the U-shaped pins may vary in size, spacing, or material to accommodate different applications. In some examples, larger pins can be used for heavy-duty frameworks, while smaller pins can be used for more delicate designs.

The threaded framework 200 also comprises anchor structures 204, which are comparable to the anchor structures 104. Therefore, the details of the anchor structures 204 are not repeated here for the sake of brevity.

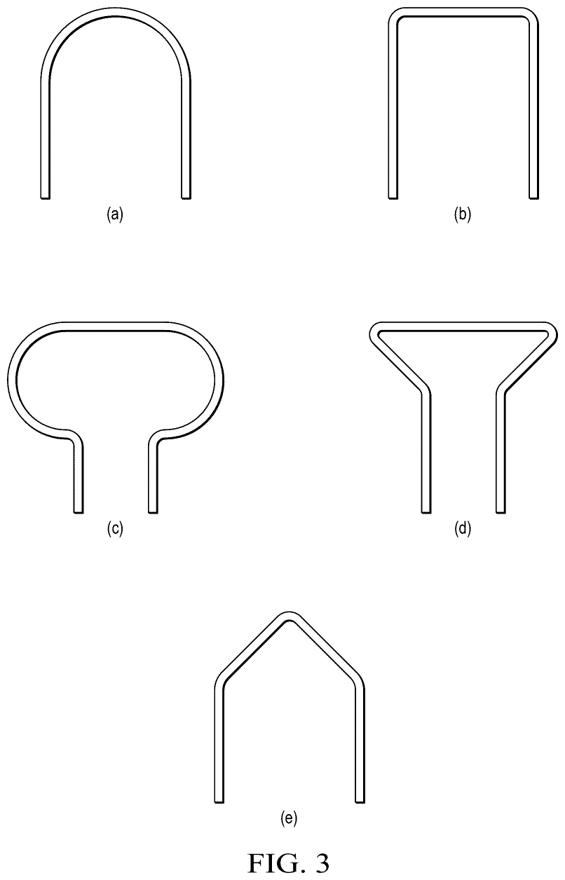

FIG. 3 illustrate several examples of the anchor structures 104 and 204: (a) an anchor structure having two legs connected by a curved portion; (b) an anchor structure having two legs connected by a straight portion; (c) an anchor structure having two legs connected by a portion consisting of three segments: two curved segments and a straight segment connecting the two curved segments; (d) an anchor structure having two legs connected by a portion consisting of three segments: two straight segments, each forming an angle with a respective leg, and a third straight segment connecting the two angled segments; (e) an anchor structure having two legs connected by a portion consisting of two straight segments, each segment having one end connected to a respective leg and the other end connected to the other segment. These examples are provided for illustrative purposes only and are not intended to limit the scope of this disclosure. The anchor structures 104 and 204 can adopt any suitable shapes or configurations to meet the specific requirements of the threaded framework.

The anchor structures 104 and 204 can have various structures and configurations that are designed to meet the functional and aesthetic requirements of the threaded framework. The anchor structures can serve as components for securing, aligning, or supporting elements within the framework.

The anchor structures 104 and 204 can include various structural elements, such as stubs, pegs, nails, knobs, spikes, or posts. Stubs can be short projections providing foundational support. Pegs can be cylindrical or tapered elements designed to fit into corresponding slots. Nails can include pointed ends for penetration. Knobs can be rounded or bulbous structures for adjustments or aesthetics. Spikes can be elongated and sharp for secure insertion. Posts can be column-like anchors supporting additional components.

The anchor structures 104 and 204 can be fabricated from a variety of materials, chosen based on the functional, environmental, and design requirements of the threaded framework. These materials can include metals, plastics, wood, or composites. In some examples, the anchor structures 104 and 204 can have a metallic material, such as steel, aluminum, or titanium. In some examples, the anchor structures 104 and 204 can have a plastic material, such as polycarbonate, nylon, or HDPE. In some examples, the anchor structures 104 and 204 can have a natural material, such as wood or bamboo. In some examples, the anchor structures 104 and 204 can have a composite material, such as CFRP or GFRP.

Referring again to FIG. 1, the threaded framework 100 further comprises one or more strings 106 that are threaded through the anchor structures 104, creating a pattern within the hollow area. In some embodiments, the strings 106 are configured to pass between the two legs of the anchor structures 104, similar to the configurations illustrated in FIG. 3. In some examples, the strings 106 are looped around at least one leg of each anchor structure 104 to maintain tension, ensuring the stability and integrity of the pattern formed within the framework. In some embodiments, when the string is threaded through the two parallel legs of the U-shaped pins, the string comes into contact with one of the legs. This contact helps secure the string's position within the pin, ensuring proper alignment and tension for the intended pattern or design within the framework.

In some embodiments, at least one of the strings is configured to loop around both legs of at least one anchor structure. For example, a string can be looped around a first leg of a first anchor structure, threaded through a second anchor structure, and then looped around a second leg of the first anchor structure.

The strings 106 can be made from a variety of materials, including metallic wires, synthetic fibers, natural fibers, or composite materials. Metallic strings, such as those made from steel, aluminum, or copper, can provide high tensile strength and durability, making them suitable for designs requiring robustness or conductivity. Synthetic fibers like nylon, polyester, or polypropylene can offer lightweight properties, flexibility, and resistance to wear and moisture, making them adaptable to various environments. Natural fibers, including cotton, jute, or hemp, contribute an organic texture and aesthetic, can be used in designs emphasizing sustainability or natural themes. Composite strings, such as those reinforced with carbon or glass fibers, can combine strength with lightweight properties, useful for advanced structural applications.

The physical characteristics of the strings 106 can vary to suit specific design needs. For example, thickness of the strings 106 can range from fine, thread-like diameters for intricate patterns to thicker cords for added structural support or visual emphasis. The flexibility of the strings 106 can also be tailored, with more rigid options used for precise alignments and highly flexible ones for adjustable or dynamic configurations. Surface finishes of the strings 106 can include smooth, textured, or polished options, contributing to grip, reduced friction, or enhanced visual appeal. The strings 106 can also have elasticity, allowing the framework to accommodate tension and adapt to dynamic forces.

The threaded framework 200 also comprises strings 206, which are comparable to the strings 106. Therefore, the details of the string 206 are not repeated here for the sake of brevity.

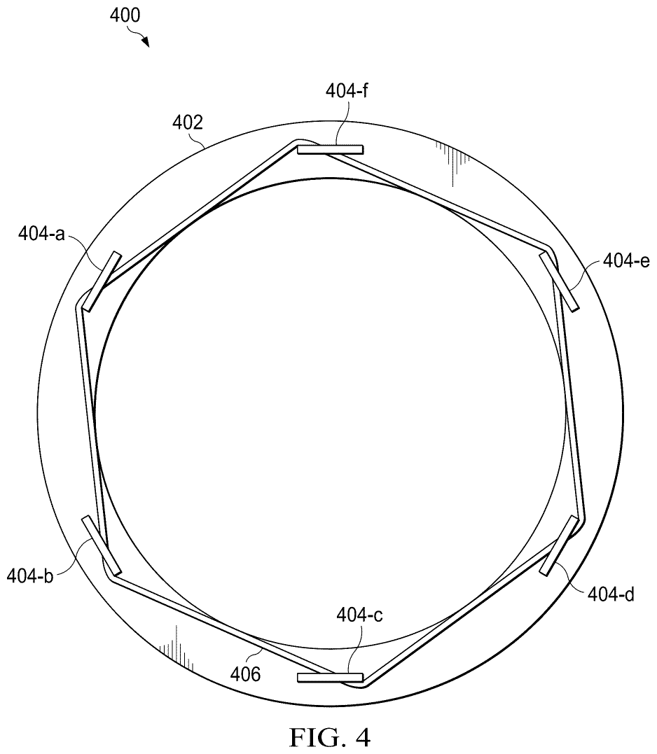

When threaded through the anchor structures, the strings can form patterns that are geometric, organic, or interwoven. These patterns can contribute to the overall visual appeal of the framework while also enhancing its structural integrity. The interplay of material choice, physical properties, and design pattern allows the strings to function as both a decorative and functional element within the threaded framework. FIGS. 1 and 2 illustrate different patterns formed by strings 106 and 206, respectively. FIGS. 4-6 illustrate other examples of how strings can be threaded through anchor structures to achieve diverse designs and configurations.

FIG. 4 illustrates an example threaded framework 400, according to one or more embodiments of the present disclosure. The threaded framework 400 comprises a base frame 402, anchor structures 404-a through 404-f, and a string 406. The base frame 402 is similar to the base frames 102 and 202, while the anchor structures 404-a through 404-f are similar to the anchor structures 104, 204, and those shown in FIG. 3. The string 406 is similar to the strings 106 and 206. For brevity, detailed descriptions of the base frame 402, anchor structures 404-a through 404-f, and string 406 are omitted here.

In some embodiments, a single string is threaded sequentially through a series of anchor structures arranged along the contour of the base frame. This threading arrangement can establish a continuous pathway through the anchor structures, providing structural connectivity and tension distribution along the base frame. For example, as illustrated in FIG. 4, the string 406 is passed in sequence through the anchor structures 404-a, 404-b, 404-c, 404-d, 404-e, and 404-f. The threading sequence is characterized by each anchor structure, except the initial one, being positioned adjacent to its preceding anchor structure within the series.

More specifically, the anchor structure 404-b is positioned adjacent to and threaded after the anchor structure 404-a. Similarly, the anchor structure 404-c follows and is adjacent to the anchor structure 404-b, and this pattern continues sequentially through the anchor structures 404-d, 404-e, and 404-f. This arrangement facilitates a straightforward and systematic threading process that contributes to the mechanical stability and functional alignment of the base frame.

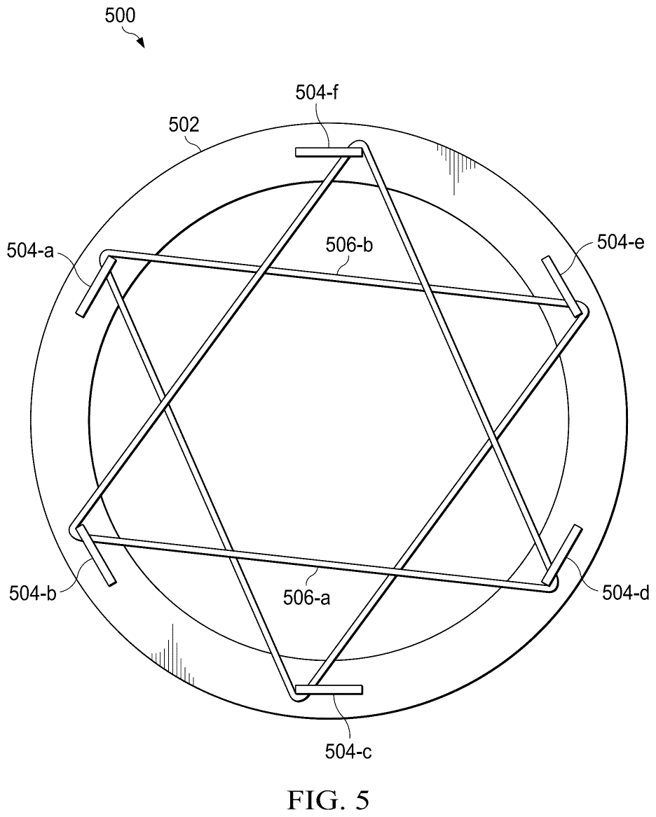

FIG. 5 illustrates another example threaded framework 500, according to one or more embodiments of the present disclosure. The threaded framework 500 comprises a base frame 502, anchor structures 504-a through 504-f, and strings 506-a and 506-b. The base frame 502 is similar to the base frames 102 and 202, while the anchor structures 504-a through 504-f are similar to the anchor structures 104, 204, and those shown in FIG. 3. The strings 506-a and 506-b are similar to the strings 106 and 206. For brevity, detailed descriptions of the base frame 502, anchor structures 504-a through 504-f, and strings 506-a and 506-b are omitted here.

In some embodiments, a single string is threaded sequentially through a series of non-adjacent anchor structures positioned along the contour of the base frame. This threading arrangement creates a discontinuous pathway, where consecutive anchor structures in the sequence are separated by at least one intervening anchor structure. As illustrated in FIG. 5, the string 506-a is threaded in sequence through the anchor structures 504-b, 504-d, and 504-f, while a separate string, 506-b, is threaded sequentially through the anchor structures 504-a, 504-c, and 504-e.

In these configurations, each anchor structure in a threading sequence is non-adjacent to its predecessor in the sequence. For example, in the threading of string 506-a, the anchor structure 504-d is non-adjacent to the anchor structure 504-b due to the presence of the intervening anchor structure 504-c. Similarly, the anchor structure 504-f is non-adjacent to the anchor structure 504-d, as the intervening anchor structure 504-e separates them. This pattern also applies to the threading of string 506-b, where the anchor structures 504-c and 504-e are non-adjacent to their respective preceding anchor structures, 504-a and 504-c.

This threading pattern can be useful in applications where it is desirable to distribute forces or tensions across the base frame in a specific non-linear or staggered manner. By threading through non-adjacent anchor structures, the design can facilitate alternative tensioning paths that can enhance the structural dynamics, prevent localized stress concentrations, and promote greater flexibility in managing mechanical loads. Furthermore, the non-adjacent threading can be utilized to create unique aesthetic effects or to enable functional zoning within the assembly, where specific regions of the frame are subject to different tensioning schemes.

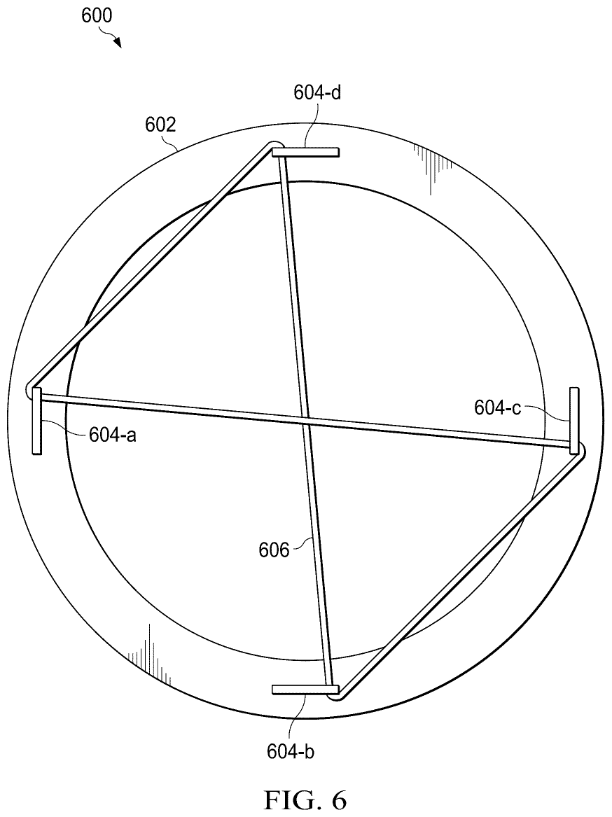

FIG. 6 illustrates another example threaded framework 600, according to one or more embodiments of the present disclosure. The threaded framework 600 comprises a base frame 602, anchor structures 604-a through 604-d, and a string 606. The base frame 602 is similar to the base frames 102 and 202, while the anchor structures 604-a through 604-d are similar to the anchor structures 104, 204, and those depicted in FIG. 3. Similarly, the string 606 is similar to the strings 106 and 206. For brevity, detailed descriptions of the base frame 602, anchor structures 604-a through 604-d, and string 606 are omitted here.

In some embodiments, a single string is threaded sequentially through a combination of adjacent and non-adjacent anchor structures arranged along the contour of the base frame. This threading arrangement can create a versatile pathway, enabling dynamic force distribution and enhancing mechanical performance. As illustrated in FIG. 6, the string 606 is threaded through anchor structures 604-a, 604-d, 604-b, and 604-c in a specific sequence.

In this sequence, the anchor structure 604-d is positioned adjacent to the anchor structure 604-a, providing a direct and continuous pathway between these two anchor structures. The threading then transitions to anchor structure 604-b, which is non-adjacent to the previously threaded anchor structure 604-d. The non-adjacency arises because anchor structures 604-a and 604-c are interposed between anchor structures 604-d and 604-b on the contour of the base frame 602. This spacing creates a discontinuity in the threading sequence.

Following the threading through anchor structure 604-b, the string 606 is threaded through anchor structure 604-c, which is adjacent to anchor structure 604-b. This return to an adjacent configuration completes the sequence, blending both adjacent and non-adjacent threading patterns in a single pathway.

The combination of adjacent and non-adjacent threading can reduce localized stress concentrations, enhance structural integrity, and provide flexibility in the arrangement of the anchor structures to meet specific design or functional requirements. The interplay between adjacent and non-adjacent threading pathways can contribute to unique aesthetic designs or functional customizations, further expanding the utility of this embodiment in specialized applications.

The threaded frameworks illustrated in FIGS. 4-6 are presented as examples and are not intended to limit the scope of the disclosure. The concepts and configurations depicted in these figures serve as illustrative examples of how a string can be threaded through anchor structures, but the disclosure is not constrained to these specific threading methods. A string can be threaded in any suitable manner, including combinations of, modifications to, or variations on the threading techniques shown in FIGS. 4-6. For example, the threading pattern can involve alternating sequences of adjacent and non-adjacent anchor structures, overlapping or intersecting pathways, or non-linear threading arrangements to meet specific design or functional requirements. Furthermore, threading pathways can be customized to accommodate different frame geometries, tensioning requirements, or aesthetic considerations, providing flexibility to adapt to various applications and use cases.

The disclosed threading methods illustrate the versatility of the threaded framework as described herein. These methods can be extended or modified to include additional anchor structures, alternative materials for the string, or adjustments to the spatial arrangement of anchor points to achieve improved performance or specific user objectives. For example, a string can be threaded in a spiral, crisscross, or multi-layered pattern, or integrated with other structural or functional elements, while still falling within the scope of the disclosure.

In some embodiments, the threaded framework comprises a first anchor structure positioned on a first surface of the base frame and a second anchor structure positioned on a second surface of the base frame, where the second surface is opposite to the first surface. This arrangement provides a threading configuration in which one or more strings are threaded through at least the first anchor structure and the second anchor structure, creating a connection that spans across the two surfaces of the base frame.

The placement of the anchor structures on opposite surfaces of the base frame can allow the threading system to establish a robust and stable connection between the two sides. This configuration can serve various purposes, such as enhancing the mechanical stability of the framework, providing uniform tension across the structure, or enabling a balanced distribution of forces applied to the base frame. Moreover, this arrangement can provide flexibility in the design and functionality of the threaded framework. The anchor structures can be aligned or arranged in specific patterns to achieve desired performance characteristics. The threading of the string through anchor structures on opposite surfaces can also enable specialized applications. For example, it can be used to secure multi-layered components, integrate different materials, or provide dual-sided support for devices or structures attached to the base frame.

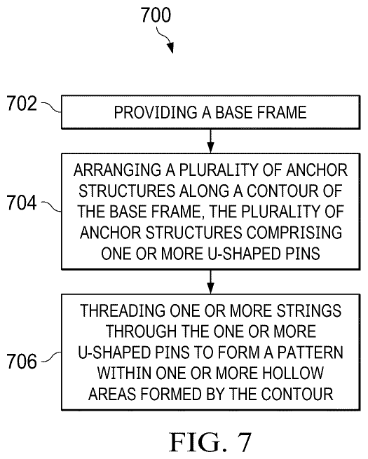

FIG. 7 illustrates a flow chart of an example method 700, according to one or more embodiments of the present disclosure. The method 700 is described in the context of the threaded framework 100 for illustrative purposes only. The method 700 can be applied to any suitable systems or elements, such as the anchor structures in FIG. 3 and the frameworks 200, 400, 500, and 600.

At 702, a base frame (e.g., base frame 102) is provided, where a contour of the base frame forms one or more hollow areas.

At 704, a plurality of anchor structures (e.g., anchor structures 104) are arranged along the contour of the base frame. In some embodiments, the plurality of anchor structures comprise one or more U-shaped pins (e.g., the anchor structures 106) placed on a first surface of the base frame. In some embodiments, each of the one or more U-shaped pins comprises two legs that are in parallel to each another and that are connected by a curved or straight portion. In some embodiments, the two legs of a U-shaped pins extend from the first surface of the base frame and are perpendicular to the first surface of the base frame.

In some embodiments, the plurality of anchor structures further comprise one or more of the following: a stub, a peg, a nail, a knob, a spike, or a post.

In some embodiments, the plurality of anchor structures comprise one or more of the following materials: metal, plastic, wood, or composite.

At 706, one or more strings (e.g., the strings 106) are threaded through the one or more U-shaped pins to form a pattern within the one or more hollow areas. In some embodiments, the one or more strings are configured to pass between the two legs of the one or more U-shaped pins, and the one or more strings are looped around at least one leg of each of the one or more U-shaped pins to maintain tension for the pattern.

In some embodiments, threading the one or more strings through the one or more U-shaped pins comprises: threading at least one of the one or more strings sequentially through two adjacent U-shaped pins.

In some embodiments, threading the one or more strings through the one or more U-shaped pins comprises: threading at least one of the one or more strings sequentially through two non-adjacent U-shaped pins.

In some embodiments, threading the one or more strings through the one or more U-shaped pins comprises: looping at least one of the one or more strings around two legs of at least one of the U-shaped pins.

In some embodiments, threading the one or more strings through the one or more U-shaped pins comprises: threading the one or more strings through at least a first U-shaped pin placed on the first surface of the base frame and a second U-shaped pin placed on a second surface of the base frame, where the second surface is opposite to the first surface.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A threaded framework, comprising:
a base frame, wherein a contour of the base frame forms one or more hollow areas;
a plurality of anchor structures placed along the contour of the base frame, wherein the plurality of anchor structures comprise one or more U-shaped pins placed on a first surface of the base frame, each of the one or more U-shaped pins comprises two legs that are in parallel to each another and that are connected by a curved or straight portion, and the two legs of a U-shaped pin extend from the first surface of the base frame and are perpendicular to the first surface of the base frame; and
one or more strings threaded through the one or more U-shaped pins to form a pattern within the one or more hollow areas, wherein the one or more strings are configured to pass between the two legs of the one or more U-shaped pins, and the one or more strings are looped around at least one leg of each of the one or more U-shaped pins to maintain tension for the pattern.

2. The threaded framework according to claim 1, wherein at least one of the one or more strings is threaded sequentially through two adjacent U-shaped pins.

3. The threaded framework according to claim 1, wherein at least one of the one or more strings is threaded sequentially through two non-adjacent U-shaped pins.

4. The threaded framework according to claim 1, wherein at least one of the one or more strings is looped around two legs of at least one of the U-shaped pins.

5. The threaded framework according to claim 1, wherein the threaded framework comprises a first U-shaped pin placed on the first surface of the base frame and a second U-shaped pin placed on a second surface of the base frame, wherein the second surface is opposite to the first surface, and wherein the one or more strings are threaded through at least the first U-shaped pin and the second U-shaped pin.

6. The threaded framework according to claim 1, wherein the plurality of anchor structures further comprise one or more of the following: a stub, a peg, a nail, a knob, a spike, or a post.

7. The threaded framework according to claim 1, wherein the plurality of anchor structures comprise one or more of the following materials: metal, plastic, wood, or composite.

8. A method, comprising:
providing a base frame, wherein a contour of the base frame forms one or more hollow areas;
arranging a plurality of anchor structures along the contour of the base frame, wherein the plurality of anchor structures comprise one or more U-shaped pins placed on a first surface of the base frame, each of the one or more U-shaped pins comprises two legs that are in parallel to each another and that are connected by a curved or straight portion, and the two legs of a U-shaped pins extend from the first surface of the base frame and are perpendicular to the first surface of the base frame; and
threading one or more strings through the one or more U-shaped pins to form a pattern within the one or more hollow areas, wherein the one or more strings are configured to pass between the two legs of the one or more U-shaped pins, and the one or more strings are looped around at least one leg of each of the one or more U-shaped pins to maintain tension for the pattern.

9. The method according to claim 8, wherein threading the one or more strings through the one or more U-shaped pins comprises:
threading at least one of the one or more strings sequentially through two adjacent U-shaped pins.

10. The method according to claim 8, wherein threading the one or more strings through the one or more U-shaped pins comprises:
threading at least one of the one or more strings sequentially through two non-adjacent U-shaped pins.

11. The method according to claim 8, wherein threading the one or more strings through the one or more U-shaped pins comprises:
looping at least one of the one or more strings around two legs of at least one of the U-shaped pins.

12. The method according to claim 8, wherein threading the one or more strings through the one or more U-shaped pins comprises:
threading the one or more strings through at least a first U-shaped pin placed on the first surface of the base frame and a second U-shaped pin placed on a second surface of the base frame, wherein the second surface is opposite to the first surface.

13. The method according to claim 8, wherein the plurality of anchor structures further comprise one or more of the following: a stub, a peg, a nail, a knob, a spike, or a post.

14. The method according to claim 8, wherein the plurality of anchor structures comprise one or more of the following materials: metal, plastic, wood, or composite.

15. A threaded framework, comprising:
a base frame, wherein a contour of the base frame forms one or more hollow areas;
a plurality of anchor structures placed along the contour of the base frame, wherein the plurality of anchor structures comprise one or more U-shaped pins placed on a first surface of the base frame, each of the one or more U-shaped pins comprises two legs that are in parallel to each another and that are connected by a curved or straight portion, and the two legs of a U-shaped pins extend from the first surface of the base frame and are perpendicular to the first surface of the base frame; and
wherein the one or more U-shaped pins are spaced out on the first surface of the base frame and configured to be threaded through by one or more strings to form a pattern within the one or more hollow areas, wherein the one or more strings are configured to pass between the two legs of the one or more U-shaped pins, and the one or more strings are looped around at least one leg of each of the one or more U-shaped pins to maintain tension for the pattern.

16. The threaded framework according to claim 15, wherein at least one of the one or more strings is threaded sequentially through two adjacent U-shaped pins.

17. The threaded framework according to claim 15, wherein at least one of the one or more strings is threaded sequentially through two non-adjacent U-shaped pins.

18. The threaded framework according to claim 15, wherein at least one of the one or more strings is looped around two legs of at least one of the U-shaped pins.

19. The threaded framework according to claim 1, wherein the threaded framework comprises a first U-shaped pin placed on the first surface of the base frame and a second U-shaped pin placed on a second surface of the base frame, wherein the second surface is opposite to the first surface, and wherein the one or more strings are threaded through at least the first U-shaped pin and the second U-shaped pin.

20. The threaded framework according to claim 15, wherein the plurality of anchor structures further comprise one or more of the following: a stub, a peg, a nail, a knob, a spike, or a post.
